(19) United States
(12) Patent Application Publication
(10) Pub. No.: US 2011/0185015 A1
(43) Pub. Date: Jul. 28, 2011

(54) SYSTEM FOR MANAGING USER SELECTED WEB CONTENT

(76) Inventor: Jordan Stolper, New York, NY (US)

(21) Appl. No.: 12/844,570

(22) Filed: Jul. 27, 2010

Related U.S. Application Data
(60) Provisional application No. 61/232,639, filed on Aug. 10, 2009.

(51) Int. Cl. G06F 15/16

(52) U.S. Cl. 709/203

(57) ABSTRACT

Managing user-selected web content using a database connected to receive and store any user-selected web content in accordance with an organizational framework. A server computer executes a plurality of code modules including a communications module in communication with a user-interface component on a client computer. The communications module receives and stores website content and pushes alerts to the client. A parser module transforms at least a portion of the content into a normalized text which is extracted into a set of terms by an extractor module. An inference engine compares at least the set of terms to an offer database using a criterion and an alert processor responds to the comparison by constructing alerts that are served to the user-interface component of the client. A system includes both the client and server computer components.

This application claims the benefit of priority from U.S. Provisional Application Ser. No. 61/232,639, filed on Aug. 10, 2009, entitled “System for Managing User Selected Web Content,” which is hereby incorporated by reference as if set forth in its entirety herein.

### FIELD OF THE INVENTION

The present invention relates to improvements in managing web content and more particularly to a computer-implemented system and method for managing, sharing and processing of user-selected content such as delivered through a distributed computer network including the Internet.

### BACKGROUND OF THE INVENTION

There is a need in the art to improve the way in which web content is noted, shared, and utilized in planning an activity such as a trip. Users that have an interest in certain content can further benefit if the content in which they have indicated an interest were to be the basis for targeted, time-relevant commercial offers that are pertinent to the content selected and being managed. Still further benefits would arise from being able to share such content and offers. The present invention addresses these and other needs.

### BRIEF DESCRIPTION OF THE DRAWINGS

FIG. 1 illustrates a schematic system diagram of a user-selected content management system in accordance with one embodiment of the invention.

FIG. 2 is a flowchart illustrating one process flow for a user-selected content management system in accordance with an embodiment of the invention.

FIG. 3 illustrates a toolbar of a conventional browser application that includes an alert notification that is inter-operative with a add-on component version of a user-selected content management system in accordance with an embodiment of the invention.

FIG. 4 illustrates an example window of a user-interface component that is configured to initiate a content management session with a user.

FIG. 5 illustrates an example of the user-interface component that is window configured to register a particular user with a server that hosts the content management system.

FIG. 6 illustrates an example of a main window for the user-interface component that permits navigation to and storage of user-selected content and a trip-builder tray that is used to establish an organizational framework (e.g., selection of folders) for management of any user-selected content.

FIG. 7 illustrates the main window of FIG. 6 after a single trip (framework) has been constructed.

FIG. 8 illustrates a portion of a conventional browser window displaying a particular website concerning information about hotels in New York.

FIG. 9 illustrates user-selected content that has been dragged into the framework of the main window of FIG. 7, and further illustrates trays that expand to provide details of the contents of a “hotels” folder that is part of the trip-builder framework in the illustrated example.

FIG. 10 illustrates a portion of a conventional browser window displaying a particular website concerning information about restaurants in New York.

FIG. 11 illustrates user-selected content that has been dragged into the framework of the main window of FIG. 7, and further illustrates trays that expand to provide details of the contents of a “food & Drink” folder that is part of the trip-builder framework in the illustrated example.

FIG. 12 illustrates a portion of a conventional browser window displaying a particular website concerning information about flights to New York.

FIG. 13 illustrates trays that have expanded to provide details of the contents of a “Flights” folder that is selected or that has had content dragged thereupon, which is part of the trip-builder framework in the illustrated example.

FIG. 14 illustrates trays that have expanded to provide details of several separate pieces of content associated with a “Do” folder that is part of the trip-builder framework in the illustrated example.

FIG. 15 illustrates a trip-builder tray as in FIG. 6, now showing the creation of a second organizational framework for independent management of user-selected content in association with second framework different than the framework of FIG. 6.

FIG. 16 illustrates the main window of FIG. 6 after a second trip (framework) has been constructed.

FIG. 17 illustrates a travel-document tray that can be called-up upon user-interaction with the main window in order to define an output report concerning one or more frameworks that have been constructed.

FIG. 18 illustrates an electronic message in the form of an email that includes as an attachment a travel report constructed based on user input to the travel-document tray of FIG. 17.

FIG. 19 illustrates an example travel document/report that is constructed by the content management system using prescribed user-selected content.

FIG. 20 illustrates a process flow for the creation and delivery of a travel report in response to interaction with the travel-document tray of FIG. 17.

FIG. 21 illustrates a further aspect of the content management system in which information such as offers for flights, hotels, etc. and the like is selected and pushed to the user for display to the user, such as under an arrivals tab in the main window of the illustrated embodiment, wherein the information can be selected in view of parameters input to the trip-builder tray and content selected by the user and placed within the framework (e.g., Hotels, Flights, Food & Drink, and Do folders).

### SUMMARY OF THE INVENTION

In accordance with one aspect of the invention, a computer-implemented system for managing user-selected web content comprises a database connected to receive and store any user-selected web content in accordance with an organizational framework. A client computer has a processor executing code that configures the client to provide a user-interface component through which a user selects web content and associates the user-selected web content with the framework. A server computer is connectable to the client and has a second processor executing a plurality of code modules. These code modules configure the server. There is a communications module in communication with the user-interface component of the client that receives content from any of a plurality of websites, stores the content in the database, and pushes one or more alerts to the client. There is a parser module that is operative to transform at least a portion of the content into a normalized text. There is an extractor module that is operative to receive the normalized text and extract a set of terms. There is an inference engine that is operative to compare at least the set of terms to an offer database using a criterion. Also, there is an alert processor that is responsive to the comparison to construct the one or more alerts and serve the alerts via the communications module to the user-interface component of the client.

In accordance with another aspect of the invention, a computer-implemented system for managing user-selected web content received from a client computer over a network comprises a database connected to receive and store any user-selected web content in accordance with an organizational framework associated with the client. A server computer is connectable to the client and has a processor executing a plurality of code modules that configure the server. One code module is a communications module that is in communication with the client to receive the content together with a location within the framework, store the content in the database using the location, and push one or more alerts to the client. A parser module is operative to transform at least a portion of the content associated with the location into a normalized text. An extractor module is operative to receive the normalized text and extract a set of terms. An inference engine is operative to compare at least the set of terms to an offer database using a criterion. An alert processor is responsive to the comparison to construct the one or more alerts and serve the alerts via the communications module to the client.

These and other aspects, features, and advantages of the present invention, some of which are detailed in the claims attached hereto, can be further appreciated from the following discussion of certain embodiments of the invention taken together with the drawing figures that illustrate the embodiments thereof.

### DETAILED DESCRIPTION OF CERTAIN EMBODIMENTS OF THE INVENTION

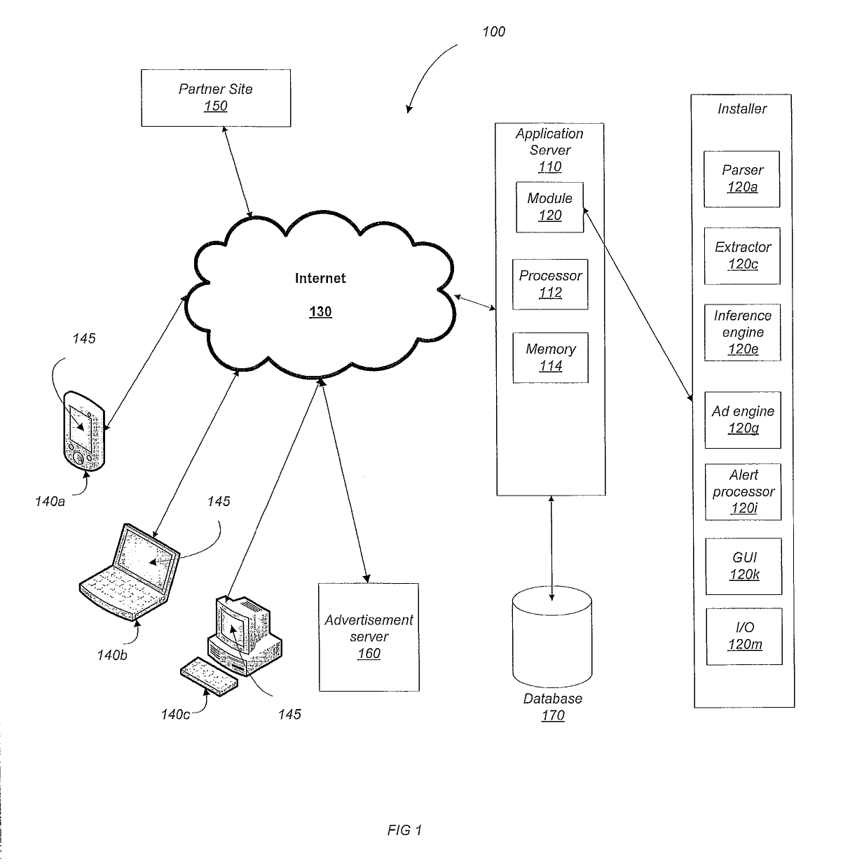

In accordance with a broad aspect of the invention, embodiments are described of a computer-implemented system and a method for managing, sharing and processing user-selected from the Internet or other resources as may be available through a distributed computer network. FIG. 1 illustrates a system diagram 100 that utilizes an application server 110 (“server”). The server hosts different software modules and peripheral devices. The server includes a processor 112, a memory 114, and code modules 120. The memory stores data and instructions from the code modules that are executed by the processor. Implementation of the memory can be by any conventional storage media such as a magnetic tape, an optical storage media, a compact disc, or a floppy disc. Alternatively, the memory can be a random access memory, a read only memory, or other type of electronic storage. The memory, at least in part, can be located on a remote storage system.

The server 110 is communicatively coupled to a distributed computer system such as the Internet 130. Communications comprise conventional, bidirectional transmission of information between the server, other resources 150, 160, 170 (described below), and client computers 140. For instance, communications can be over plural network segments, both public and private, and can include both wired and wireless networks. A variety of protocols can be used for the communications; the communication mechanism can be conventional as it forms no part of the present invention.

Users interested in gaining the functionality provided by the application server 110, access the server through Internet 130 from a client computer (“client”) such as clients 140A (a personal digital assistant (PDA)-style device), 140B (a laptop style device), or 140C (a desktop computer style device) (more generally, clients 140). The clients comprise machines of conventional construction such as the devices illustrated in FIG. 1: a notebook computer 130A; a laptop computer 130B; and a desktop computer 130C. Each client has a processor, memory and at least one input/output device such as a keyboard and a display. In one embodiment of the invention, client 140 accesses the server using a conventional browser to download code as an add-on or plug-in 145 that extends the functionality of the browser application. Hereinafter, the terms “add-on” and “plug-in” both refer to code used to extend browser functionality. The plug-in executes within the browser environment and operates to manage any user-selected content that may be selected as a result of further use of the browser (e.g., searching, linking or direct navigation to a particular URL), as will be further described below, using the code modules 120. A user drags and drops any content that he or she selects into a window of the plug-in 145, and, more particularly, into a folder or other framework component provided as locations to assist the user in sorting his or her selections.

A variety of partner sites can be accessed by the application server 110, such as partner site 150. The partner site can be travel-related sites such as sites that manage inventories of hotel rooms available for booking, cars available for renting, and flights available for booking, or can be sites that manage inventories of tickets for events and locales. A preferred vertical market for deploying the functionality of the code modules 120 is the travel service market, and for this vertical market the partner sites can be sites that provide rates for hotels (e.g. hotels.com) or airlines (e.g. priceline.com). In accordance with one aspect of the invention, the partner site provides the application server with offers (e.g., deals) and other information that is selected on the basis of the content selected by the user and certain profile information provided by the user (such as trip parameters, as discussed below). The application server processes the deals and communicates them to the plug-in for display to a user at the client 140 using a communications module that can be conventional.

Another resource available to the server 110 is an advertisement server 160. The ad server 160 can send advertisements to the plug-in for display within a window, frame or banner space provided by the plug-in. Ads also can be included in reports generated by the plug-in, such as in travel reports constructed for a user, as described below in connection with FIGS. 17-20. Alternatively, ads can be served to the application server 120 and relayed to various plug-ins for presentation to the user. The ad server provides advertisements related to user profile information, the user-selected content, or both. The ad server can be conventional. For instance, the ad server can be part of a server farm maintained by a third-party that serves ads to a variety of destinations on the Internet and other networks.

As shown in FIG. 1, the application server is connected to a database 170 and includes or is connected to a database management server such as MySQL manager queries and commits data. MySQL is one relational database management system (RDBMS) that can be utilized. The database 170 contains a plurality of records associated with each registered user, as well as other information that can be used to select and determine which deals to offer to a particular user (i.e., an offers database), and other business information incident to providing the functionality described herein. As will be understood, plural databases can be used by the server 110, and without any loss of generality, reference is made herein, for ease of discussion, to one database.

The offers database can be populated with offers from third-parties such as the partner sites 150.

A given record in the database includes user-profile information associated with a registered user such as the user's name and email address and can include further information such as an account for charging purchases or reserving flights, etc. A given record can include parameters set by the user such as one or more trips that have been defined in terms of dates of travel, destination, or features (ski resort, beach, etc.). A given record is populated over time with any user-selected content that is dragged into a framework such as a particular folder in a set of folders by user-interaction with the plug-in 145. In addition, the record is optionally populated with deals, advertisements, or both that preferably are subject-matter related to selections input by the user. As a result of user interaction with the plug-in while exploring the Internet, the code modules 120 operate to populate the database 170.

The database can include a table configured to store user-selected content in association with the framework that has been established. For instance, the framework can comprise a set of folders and the content can be stored in association with a named folder. The folders identify a location within the framework (e.g., Hotels vs. Flights) and the location can be used in picking other tables or databases for performing hashing functions as described below in connection with identifying offers that can be provided to the user as an alert.

In accordance with one embodiment of the invention, the modules 120 can be implemented as a single program. Alternatively, the modules can comprise libraries or a plurality of programs that operate in cooperation with one another. The modules (including the user-interface component, or more generally “user-interface”) are preferably embodied as software. The code modules execute on a processor of a computer, and as such configure the computer to the purpose of the combined operation of the modules. The code modules of the illustrated embodiment comprise a parser module 120a, an extractor module 120c, an inference engine 120e an advertisement engine 120g, an alert engine 120i, a graphical user interface (GUI) 120k, and an input output (I/O) interface 120m. The code modules are explained below in detail with an exemplary flow diagram and certain screen shots showing a user-interface arrangement suitable for managing user-selected content in accordance with one embodiment of the invention.

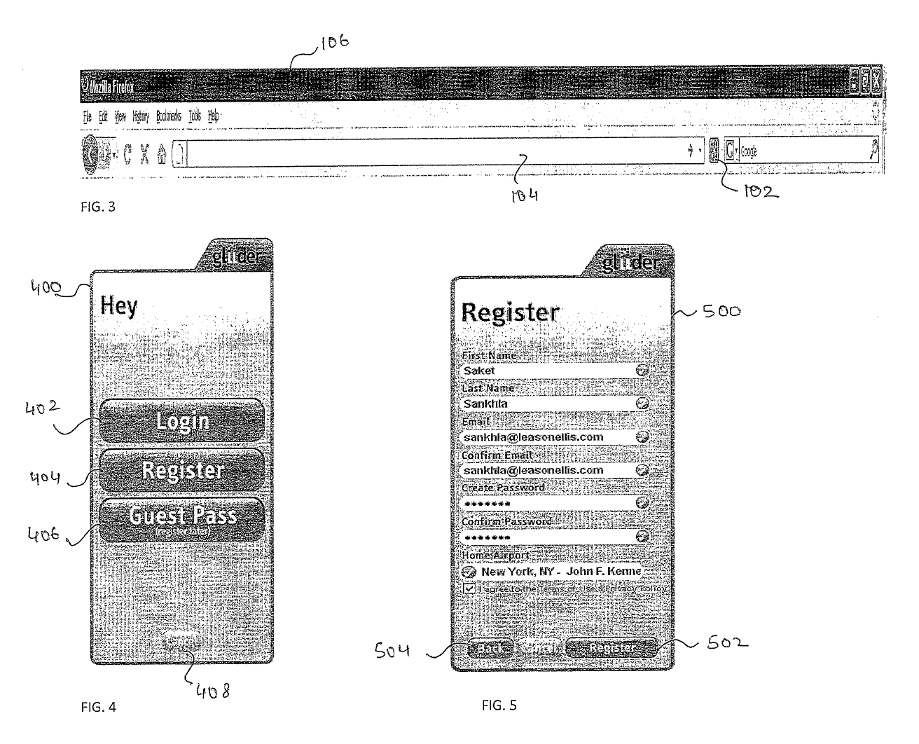

The plug-in 145 is downloaded from the application server and is installed on a client machine, such as client machine 140C. Referring now to FIG. 3, once the plug-in is installed, an icon 102 can appear on a toolbar 104 of the web browser 106. The web browser 106 can be any one of a variety of available web browsers such as Mozilla's Firefox, Microsoft Corporation's Internet Explorer and Apple Computer's Safari. The icon can be configured to flash or blink when an alert or other notification is sent or is ready to send from the application server to that particular client machine, such as when the server has offers, deals or other information that have been sent or are to be sent. Optionally, the plug-in 145 can be launched by click-selecting the icon 102. Of course, the plug-in can be launched in other ways. However, once launched, a login window 400 appears (as illustrated in FIG. 4). The login window can use extensible markup language (XML) in order to create a flexible text format for generating structured computer documents for any user-selected content. The login window of the illustrated embodiment includes four selectable choices: a login button 402, a register-user button 404, a guest button 406, and a cancel button 408. A first time user of the plug-in can register by selecting the register button. On the other hand, a registered user can select the login button and start using the application right away. A more casual interaction with the plug-in can be permitted by providing a guest pass button which permits the application to launch without the user tagging the session to his or her identity, but by instead using a different device to identify the user (e.g., a cookie). The cancel button is provided to close the interface and terminate the launch. The information entered into the application after selecting any one of the four choices can generate a cookie which stores, manages and processes the user-selected content as more fully described below.

With further reference to the register-user button 404, as soon as the register-user button is selected, a register window 500 appears (as shown in FIG. 5). The register window can include various fields that vary depending on the vertical market of the plug-in. In the illustrated example of the travel-segment, the register window can include a username, an email, a password, and a nearest home airport. In an academic-segment, the register window can include a username, an email, a password, and a university or school identifier. By selecting the register button 502, the data added to the fields in the register window are posted to the application server 110 and used to create a structured record in the database 170. For instance, the record can be constructed using one or more software languages such as XML, MySQL Python, or Django. The text entered in to the fields of the register window can be shared with one or more clients, the application server, the database, or all of these resources. A back button 504 enables the user to bring up the login window again.

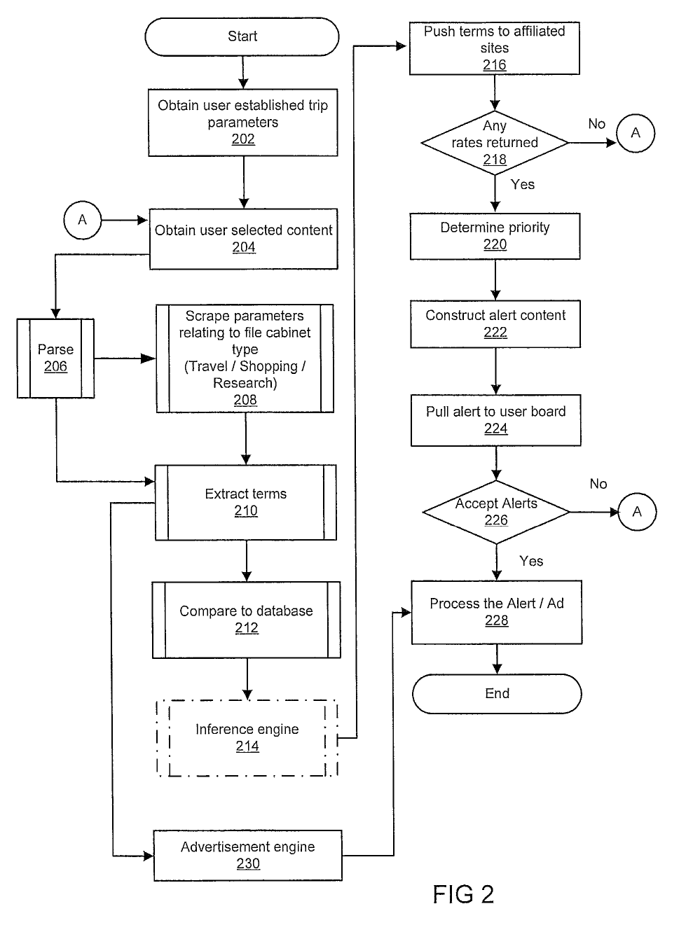

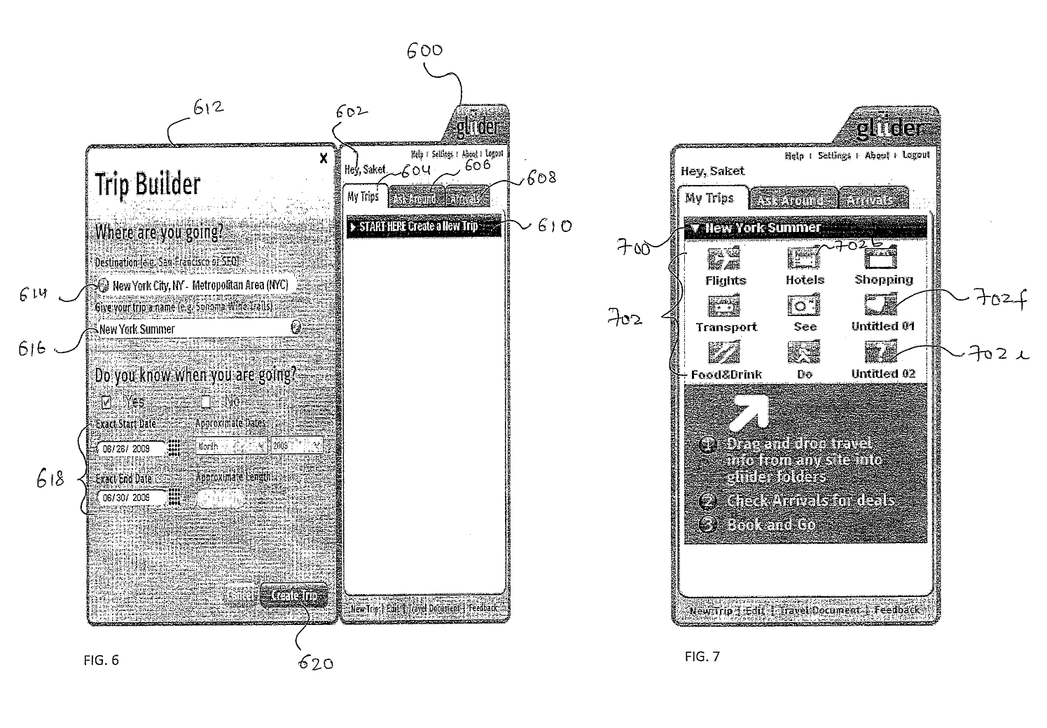

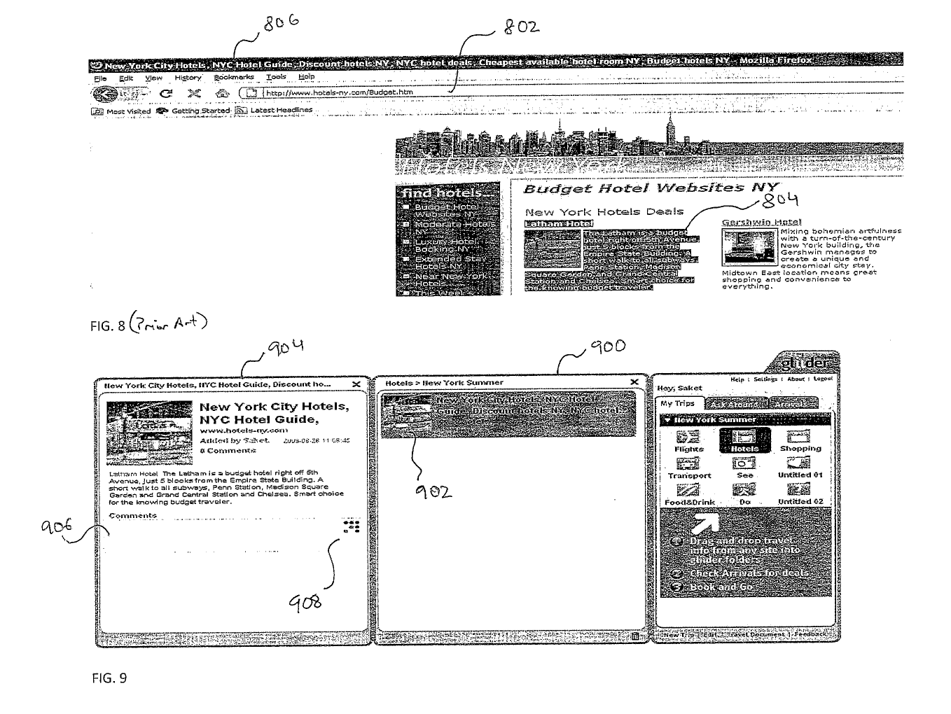

After a successful registration is completed (i.e., after the server 120 receives the data, constructs the user's record, and reverts to the client with a message confirming this has been done—all of which can happen within a short period of time while the user waits), a main window 600 is presented on the web browser (as illustrated in FIG. 6). The main window typically displays a registered-user name 602 to identify the logged-in user and several tabs including a my-trip tab 604, an ask-around tab 606, and an arrivals tab 608. The ask-around tab and the arrival tab are discussed below. A new-trip button 610 is provided under the my-trip tab and is used to identify and create a new travel itinerary. Upon selecting the new-trip button, a trip builder tray 612 opens up. The trip builder tray further includes a form having various input fields including a destination-of-travel 614 field, a trip-name 616 field, an exact-date of travel 618 field, and an approximate-date field. The destination-of-travel field can provide a drop-down menu of destinations and airports. A trip-name is an identifier to identify the name of the destination that is to be travelled. The user can select either an exact-date of travel or an approximate-date of travel, e.g., using radio buttons. Start-date and end-date text boxes are provided, and a calendar pop-up can be provided to facilitate date-selection. The create trip button 710 constructs user established trip parameters 201 (as shown in FIG. 2) and posts this information to the database 170. The trip parameters are preferably associated with an organizational framework such as a selection of folders (Flights, Hotels, Food & Drink, etc.), and are further associated with the logged-in user (or guest) so that any user-selected content can be managed in accordance with the organizational framework. As an example, content selected and placed in a Hotels folder 7026 (FIG. 7) can be parsed, extracted, and compared to a database of offers for hotels in the destination city defined in the trip parameters.

The user-established trip parameters can be communicated to and shared with the application server 110, the database 170, the advertisement server 160, and any partner sites 150. The trip parameters can be stored in the database, such as in a record as previously described, using a database management system (DBMS) such as MySQL.

After the create-trip button 620 is selected, the trip-builder tray closes and a main window opens including a file cabinet 700. The file cabinet is identified by the trip name 616 and contains one or more folders 702 such as flights, hotels 702b, shopping, a transport, see, food and drinks, to do, untitled 01 and untitled 02 (as shown in FIG. 7). The untitled folders 702f and 702i are optional, and in one embodiment can be user-named folders that the user can place content of interest (e.g., books to read). In FIG. 7, the file cabinet is expanded to reveal the organizational framework, which as illustrated is a set of folders. The folder can be click-selected to toggle between the un-collapsed and collapsed presentation of the file cabinet.

In accordance with a salient aspect of the invention, the content management system hosted by server 110 is configured to provide offers such as travel offers from one or more partner sites. Information entered by a user into the framework (e.g., into a folder created by the trip builder) is communicated to the partner site(s), or to the ad server 160, preferably via the server 110. Alerts are provided to clients 140 based on such information. When a new alert is sent to a particular plug-in 145, the icon 102 included on the address bar of the browser window of FIG. 3 can flash to indicate the receipt of an alert from the partner site or the advertisement server. In the discussion that follows, the selection and capture of content using the plug-in is described in further detail.

FIG. 8 illustrates a Website 802 the subject matter of which concerns hotels. The website is viewed from within a web browser and a portion of content 804 of interest to the user can be selected, as shown, for example, by clicking a mouse at one edge of the content and dragging the mouse to another edge before releasing the mouse-button. The selected content can include a text, an image, a hyperlink to further information, or all of these elements. Associated with the selected content are the source URL of the hotel website 802 and the title of the displayed webpage 806. The selected content can be dragged and dropped into the organizational structure created for the user. In the illustrated example, the organizational structure is a file cabinet having a set of folders, including among others a folder entitled “Hotels.” The ability to drag and drop content is an existing feature in some web browsers. For example, Mozilla's Firefox web browser supports this functionality, and provides the URL and title information in association with the selected content.

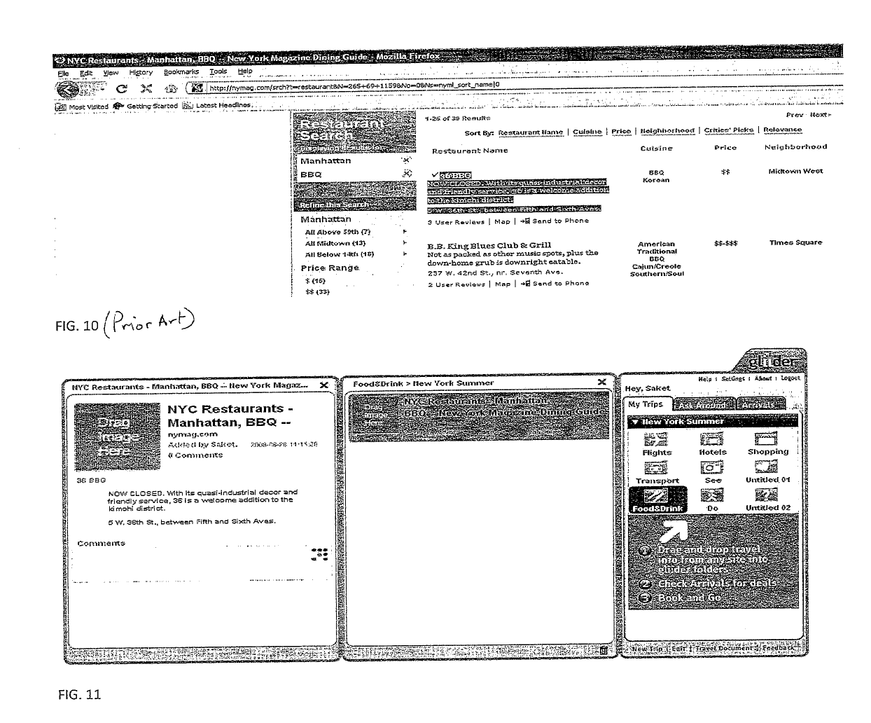

Referring to FIG. 9, the selected content can be dragged to any of the folders of the framework entitled “New York Summer.” As illustrated, the “Hotels” folder is highlighted by moving the mouse over that folder and dropping the selected content into that folder. Upon dropping the content in to the folder, the selection is communicated to the application server 110 using a conventional messaging protocol (e.g., UDP) over a channel that is established between the plug-in 145 and the server 110 when the plug-in is launched. In other words, the selected content is communicated, in response to user action with a user-interface module of the plug-in, to the server for storage at the database 170. The message that sends the content includes information that identifies which portion of the framework (e.g., which folder) at the client computer into which the user has dropped the selected content to thereby associate the user-selected content with the framework.

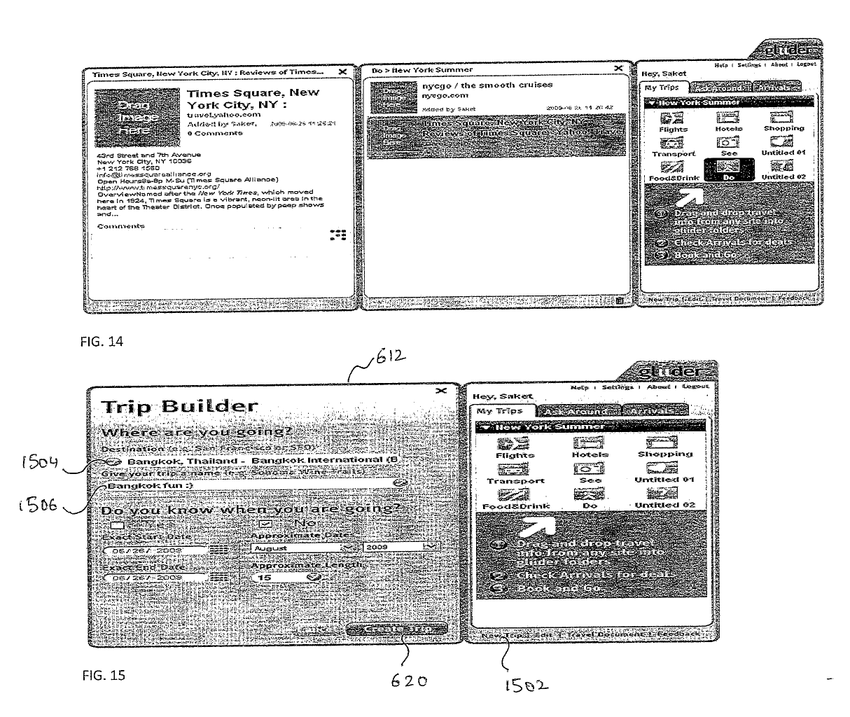

The user-interface module 120K of the plug-in responds to selection of a particular portion of the folder by calling up further windows referred to herein as “trays.” For instance, in FIG. 9 the “Hotel” folder is selected (shown highlighted), and upon click-selecting this folder, a call is made to the application server to retrieve any user-selected content that has been dragged into and thereby associated with that folder in that particular file cabinet (“New York Summer”). As illustrated, a first tray 900 appears to one side of the main window. The first tray identifies the “open” folder name and the “file cabinet” name (702b, 700). The application server retrieves content from the database 170 and sends the content that corresponds to the interaction of the user with the user-interface, which in this example is selection of the New York Summer/Hotels folder. The plug-in receives the content from the application server in a message received over a communication channel and unpacks the message so as to display the content in the body of the first tray 900. In this way, the first tray provides a contents directory of any information that the user may have selected and placed in that folder. The contents directory can identify, for a given piece of selected content, the title 806 of the web page from which the content was captured, an image 902 of the hotel or another image if an image was dragged into the folder, or a default image or icon if no image was so-dragged. (FIG. 14 illustrates two separate entries.) Any entry in the contents directory can be click-selected by the user interacting with the user-interface module to cause a second tray 904 to open. The second tray includes further details of each piece of selected content. The details can vary in any given implementation, but can include the title, the selected content 804 such as the image, the text, the URL, the date and time when the information was selected, and the user name that selected the content. Optionally, the second tray can further include a comments section 906 in which the logged-in user can provide comments for this selected hotel section, or other users can provide comments. An icon 908 can be selected or clicked to post and share the comments with other users.

Optionally, upon creating a file cabinet using the trip-builder tray, the logged-in user can identify other users of the plug-in and set sharing privileges to permit others to read, edit, and augment a particular file cabinet. This facilitates planning and sharing of ideas among friends. Also, if sharing is permitted, new content added by one user can cause an alert to another user who is identified as having share-privileges. The alert can be directed to the plug-in, or can comprise an email message, email attachment, a text message, etc. Likewise, if sharing is enabled, any comments by one user can cause such messages to be sent to other users in support of information sharing.

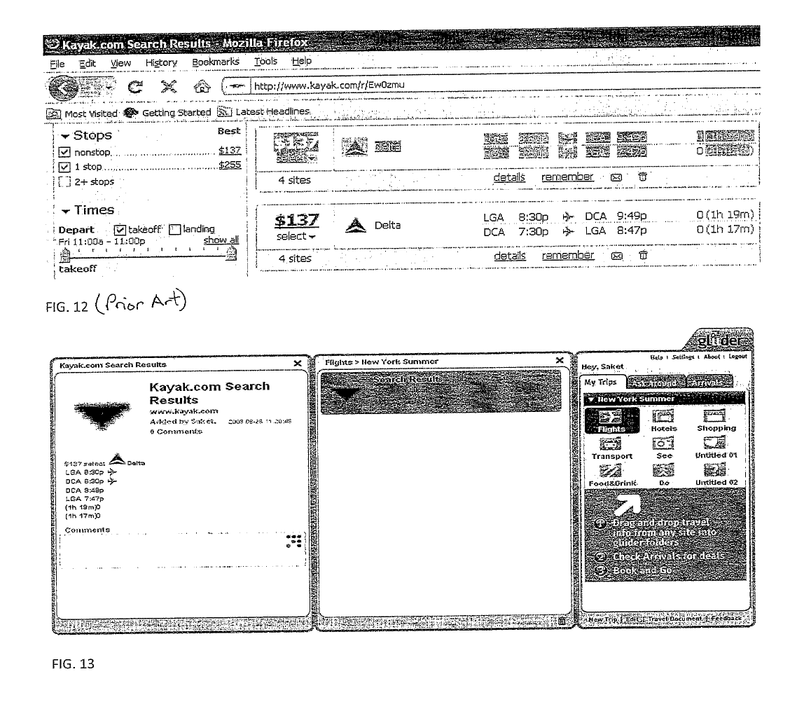

With brief reference to FIGS. 10-14, as can be appreciated, the user can review pages of any of a variety of websites such as shown in FIGS. 10 and 12 and using the same actions described above, can select and drop content into desired portions of the framework, such as any of the folders 702. Regardless of the source-site for the selected content, upon dropping the content into the framework, the plug-in sends to or exchanges messages with the application server 110 and conveys the selected content for storage in the database. The database pushes the relevant information to the application server and the information that is displayed in the body of that tray.

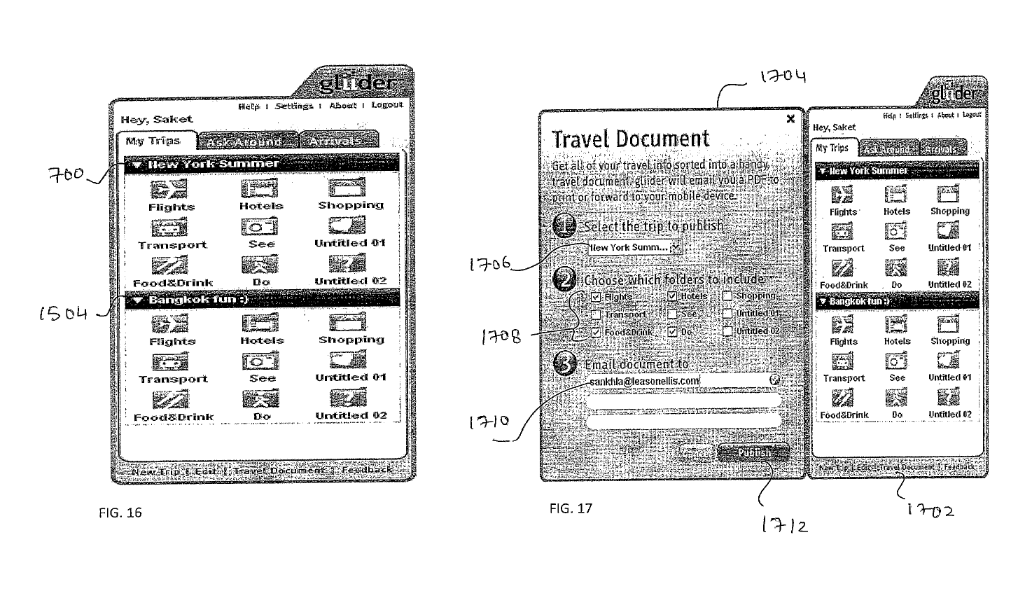

With brief reference to FIGS. 15 and 16, additional frameworks can be defined (e.g., additional trips, research projects, etc.) and added for presentation in the user-interface by selecting the new-trip 1502 button in the main window 600. The new-trip button opens the trip builder tray 612. The trip builder tray includes a form having a destination-of-travel 1504 field, a trip name 1506 field, and so on as previously described. The destination-of-travel field can provide as a drop-down menu a list of destinations and airports. The trip name is an identifier to identify the name of the destination that is to be travelled. The user can select either an exact date of travel or an approximate date of travel using radio buttons or other interactive controls. Start-date and end-date text boxes can be augmented with a calendar pop-up to facilitate date entry in a conventional manner. The create-trip button 620 is selected after all the fields are entered in the trip builder form. The create-trip button causes user-established trip parameters 201 to be forwarded to the server, which, in turn, instructs the database 170 to construct a framework for the newly created trip. The trip builder tray closes after the create trip button is selected and the main window 600 opens up to show the file cabinet 700 with the newly-selected travel destination 1504.

Referring now to FIG. 2, a process flow concerning the processing of user-selected content by the server 110 is described in connection with the Internet activity of a user at a client computer 140 in accordance with one embodiment of the invention. At block 202, content received in a message or otherwise conveyed from a plug-in 145 executing at a client computer 140 provides the server with user-established parameters such as the trip parameters entered into the trip-builder tray 612. The trip parameters define a date range or period of time that provides a criterion for searching for offers, discounts, advertisements and the like. The Trip parameters can also define a destination that provides an additional criterion to filter among offers, discounts, ads and so on. The logged-in user may have further profile information in the database 170 that can be used in connection with providing offers, but at block 202 it is the set of trip parameters that are obtained.

Next, at block 204, any content that has been dropped into the framework (e.g., the “Hotels” folder) is obtained by the processor for processing by one or more of the modules 120a-i. As described above, upon selecting content, the plug-in conveys the selected content to the server 110. The server monitors incoming messages from plug-ins that may be received from time to time across a network such as the Internet 130 and spawns a parsing thread, at block 206, using the parser module 120a. The parsing thread causes the selected content to be processed so as to generate normalized text. More particularly, the parser module includes a set of rules that operate upon text in the selected content to transform the terms into normalized text for further processing. The parsing thread generates the normalized text by a series of steps such as identifying non-html text, converting abbreviations to standard terms (e.g., St. and Saint both become Saint), and removing any punctuation. The output of the parsing module 102a includes normalized text. In the case of the Hotels folder, it is expected that the normalized text will include, among other terms, a hotel name, an address of the hotel, a date and time when the information of the hotel was published in the web site, or possibly other related information about the hotel. For other folder types, the information can identify airlines and flights, restaurants and activities, but processing by the modules 120a-l is the same regardless of the folder contents, and so the present example is not meant to be limiting of the scope of the invention, but rather illustrative of its operation.

At block 208, parameters related to the type of file-cabinet are scraped from user profile information. Thus, in the example shown, the file cabinet concerns a trip for travel to a destination. Other file cabinet types (not illustrated) can have standard frameworks (e.g., sets of folders) that are pertinent to shopping, research or other vertical market applications. The scraped user-profile information can include personal information outside of the scope of any content captured by the user, and such information is useful in providing meaningful deals, offers, and ads to the user. For instance, the user-profile information can include data captured by the trip-builder tray 612, such as the dates that the user intends to be in New York. That information, combined with, say, a selection of the “Latham Hotel,” can enable the further modules (discussed below) to provide room rates, room availability, and other offers to the user for that specific time period that may be of interest to the user.

At block 210, the extractor module 120c processes the normalized text and the scraped information in order to present the terms to a database for comparison and matches based on a criterion or several criteria. The extractor module communicates with the database 170 or another database to identify an actual hotel (in this example) from the content of the normalized text and, optionally, the context of the extracted terms. The database can be provided by a third-party partner site 150.

The extracted terms are applied to a database, at block 212. The database can contain an array (list) of all hotels in association with one or more geographic regions. The extracting step includes a hashing function that applies the normalized text to the database in order to convert all of the output of the parser module 120a into a subset of terms that provide an index that resolves into particular entries in the array of hotels. The hashing function detects duplications or similar records, and preferably maps two or more keys to the same hash value to detect a primary match (e.g., “Latham” and “Hotel” both hash to the array, but “Latham Hotel” provides a primary match). If there is a match with the normalized text, a text dictionary or an index containing the relevant match is prepared. For example, a first hash compares a first word of the hotel name with the list of hotel names stored in the database. If the first word matches, a second hash compares the second word of the hotel name and this process goes on until an exact match is found. However, if the first word does not match with the first word of the hotel name then the next hotel name is compared. After matching the exact hotel name, the hashing function matches the geographical area of the hotel, and distance from airport to hotel. Once the hashing is complete, the extractor module structures a record or message that includes the final set of extracted key parameters, which in the present example are one or more hotel names.

Optionally, at block 214, the extracted key parameters are provided to an inference engine that operates to identify other objects that fall within a prescribed criterion or criteria as compared to the extracted key parameters. Thus, for instance, if the only hotel identified from within the user-selected content as a result of processing at blocks 210, 212 is “The Latham Hotel,” the inference engine 120e can be run at block 214 to identify additional hotels that are match “The Latham Hotel” in one or more characteristics. For instance, the inference engine can past this hotel and the destination city to a partner site and retrieve the identity of other hotels that have the same rating, comparable or preferably lower pricing, or other matching characteristics (downtown, golf course, family friendly, etc.). A hashing function can again be used to find such other further matching objects in addition to the matches in view of the exact object. The results from the inference engine are derived from the normalized text and/or the extracted key parameters.

As will be appreciated, the inference engine can operate continuously to compare at terms derived from the user-content to an offer database so as to cause a series of alerts to be generated over time.

At block 216, the extracted key parameters (e.g., The Latham Hotel, or any other object) are passed to an affiliate site, together with the file-cabinet information (e.g., the date information obtained from the trip-builder tray). This information comprises search criteria that the partner site applies to its database. If there are matches, the partner site returns to the server 110 a set of matching hotels, the room rates, availability, hotel rating, geographical area, radius from airport to hotel and other related information of the hotel such as is typically available from various websites such as hotels.com, priceline.com, Hilton.com, etc.

At block 218, a test is made to determine whether any responses have been received. It could be that that there are no matching offers. For instance, the user may have selected a local hotel or a bed and breakfast that has no online offers or booking, or may have selected a hotel for which there is no availability and for which the inference engine, if used, did not find a comparable hotel to have quoted. In that case, the server 110 does no further processing, and rather loops back to node A to await further user-selected content and then repeat the processing at blocks 204 through 218.

On the other hand, if any rates are returned by the partner sites 150, then the alert processor module 120i operates upon the results at block 220, among other things, to determine a priority among the matching results. For example, if the extracted key parameter were the Ritz-Carlton hotel and the partner site obtained a rate quote of $500/night in New York, and the inference engine 120e determined that three additional hotels satisfy the match criteria, the alert processor module 120i can operate to make a selection among the inference engine results so as to limit the number of hotel offers sent to the user. The filter as to how many and which hotels are to be offered can be established on any number of criteria, including some criteria that benefit the host of the application server, the partner site, or both. Thus, the alert processor module 120i can select one additional hotel to present to the user through the plug-in 145, such as the Four Seasons hotel if it had availability in the same city/neighborhood, on the same night(s), at a more attractive rate (say, $450/night).

As indicated at block 222, the alert processor 120i also operates to construct an alert for transmission to the user. The alert processor constructs alerts using content that has been selected after the priority-determining step. The matches that have sufficient priority are arranged into a standard format such as a shown in FIG. 21, in which the alert identifies the trip, (“Los Angeles—LA Trip 2009”), the date and time of the offer, and the terms of the offer. The alert processor constructs the alerts, in part, by populating a template with data received from partner sites and with data from the file-cabinet parameters. In the illustrated embodiment (see FIG. 21), the alert message is arranged as HTML text on the main page 600, under an arrival board tab 608.

At block 224, the plug-in, once launched, sends a message to the server 110, e.g., a request signal, to retrieve from the server any alerts or other information that the server has for this logged-in user. Any alert is then pulled from the application server to the user, preferably, into the plug-in. Alternatively, the alert message can be sent to the user via an email message, or as an email message attachment, or can otherwise be pushed to the user. Another alternative is that the icon 102 on the address bar of the web browser can be flashed to indicate the receipt an alert or an updated alert from the application server that can be viewed by opening the plug-in.

In FIG. 21, the arrivals tab 608 has been selected to bring to the foreground two alerts that have been pulled from the server. Each specifies the name of a hotel and a room rate. Each alert includes controls that enable the offer to be accepted from within the user-interface of the plug-in, to dismiss the alert while indicating an interest to receive a better price, or cancel the alert. The controls can comprise respective hyperlinks that convey messages to the server 110 for action consistent with the user's selection. At block 226, a test is made to determine whether the offer in a particular alert has been accepted. If the action (or inaction) is other than accepting the alert, then the server is configured to loop back to block 204 to repeat the steps in response to any further user-selected content being obtained. On the other hand, if the alert has been accepted, then at block 228 the alert is processed. Processing can include a variety of steps including initiating a booking process at a website and external to the user-interface, or completing a reservation of a room, purchase of tickets, etc. through a window opened in response to use of “accept” control. If the transaction is completed at a third party site, parameters are passed to that site to identify the particular offer being accepted and permit referral fee accounting for the benefit of the entity that is hosting the application server 110.

The process of FIG. 2 can also include passing of normalized terms to an advertisement engine 120g which is configured to generate targeted advertisements on the basis of the normalized text or the structured key parameters from extractor module 120c. The advertisement engine can include a database containing banner advertisements and other advertising-related data. Optionally, the advertisement engine can push advertisement to the application server or directly to a plug-in if the user-interface is configured to receive ads. Alternatively and in addition, ads can be included in travel documents as discussed next.

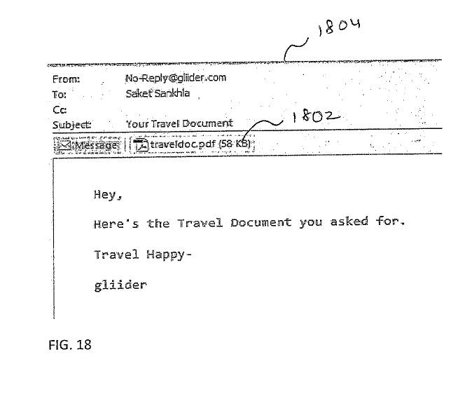

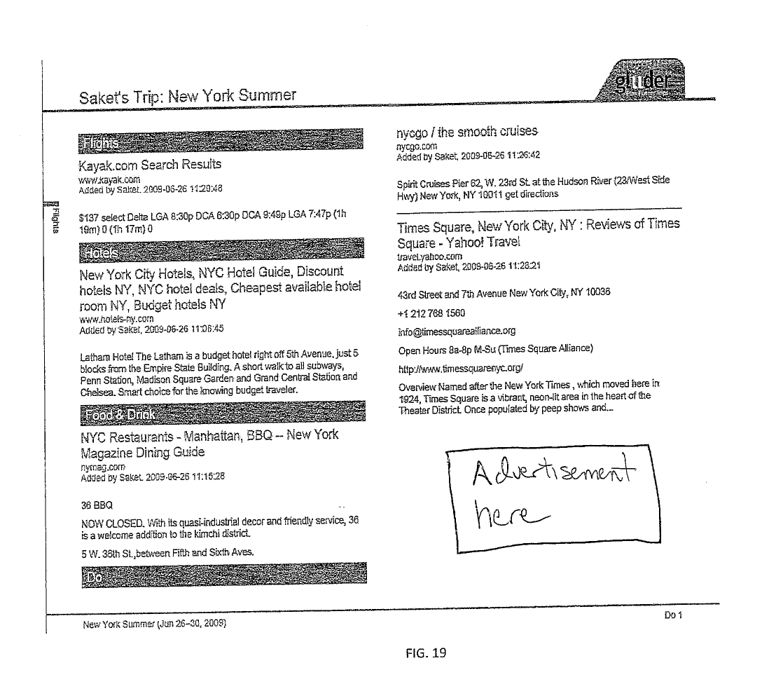

Referring now to FIGS. 17-19, the user can generate a travel document by selecting the travel-document button 1702. Selecting the travel document button opens a travel document tray 1704. A trip can be published by the user from the travel document tray by selecting the pull-down menu 1706 or by otherwise inputting document-format and document-content selections. The pull down menu includes the file cabinet names (700, 700a). The user can select the desired file cabinet to be published along with the folders associated with it. The user can also choose the folders 702 to be published such as the Flights, Hotels, and Do folders by selecting check boxes 1708. The publication of the travel document can be shared or sent to the user by entering one or more email addresses 1710. A message is sent to the application server when the publish-button 1712 is selected. If the travel report is to be sent by email, then it is forwarded by the server to the email address(es) identified by the user, as shown in FIG. 18. The content of the travel report can be as shown in FIG. 19, and include the user-selected content from a variety of web pages without other material from those web pages. As a consequence, the travel report provides a concise report of the information of interest to the user, with links back to the source pages for further review and information. Such a report can be used in a variety of contexts outside of the travel services market. Optionally, the report includes an ad served by the advertisement engine 120g.

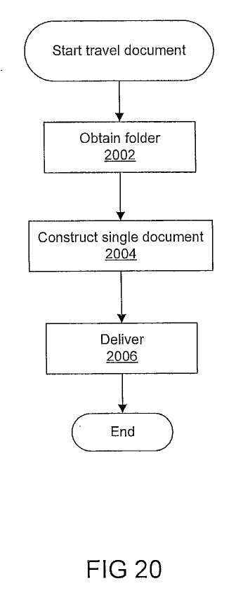

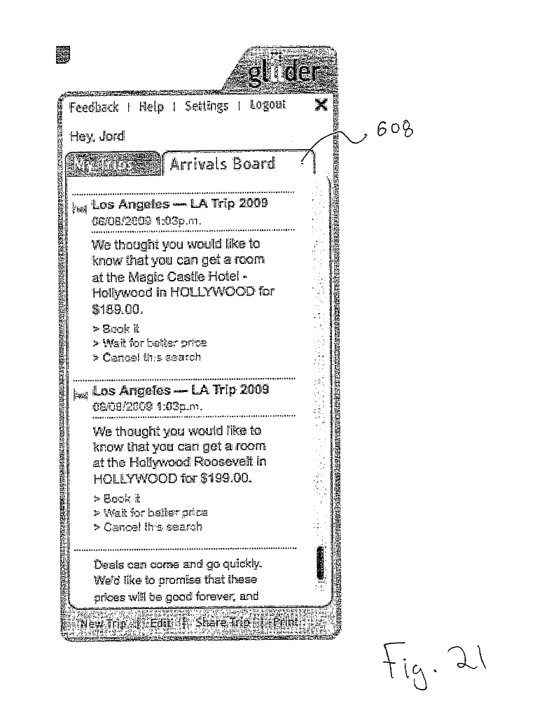

FIG. 20 shows the process for creation of a travel report. The application server 120 processes the travel document by obtaining the data from the selected folders, as indicated at block 2002. The information obtained is all or a portion of the user-selected content, including images. The information can also include comments added by the logged-in user or any acquaintances that have sharing permission. At block 2004, a single document is constructed such as shown in FIG. 19. The single document comprises a report (in this example, a travel report), that can be distributed to the logged in user, such as by delivery to an email address as indicated at block 2006 (see FIG. 18). The report includes any user-selected content, as well as any ads that are determined to be served to that user, and preferably file-cabinet parameters to identify the report, such as “New York Summer.” The content in the report preferably includes active hyperlinks back to the source documents and to any offers or ads included therein.

It will be appreciated that, instead of storing user-selected content at the database 170, in an alternative arrangement the selected content can be stored locally on the client computer 140 and messages to the application server 110 can provide the selected content or the normalized text for processing at the server, but not for storage at the database 170.

It will also be appreciated that elements of embodiments of the present invention can also be provided as a machine-readable medium for storing the machine-executable instructions. The machine-readable medium can include, but is not limited to, a flash memory, an optical disk, a CD-ROM, a DVD ROM, a RAM, an EPROM, an EEPROM, a magnetic or optical card, or other type of machine-readable medium suitable for storing electronic instructions.

The embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions can be loaded onto one or more general purpose computers, or other programmable data processing apparatus to produce machines, such that the instructions which execute on the computers or other programmable data processing apparatus create means for implementing the functions specified in the block or blocks. Such computer program instructions can also be stored in a computer-readable memory that can direct a computer or other programmable data processing apparatus to function in a particular manner, such that the instructions stored in the computer-readable memory produce an article of manufacture including instruction means that implement the function specified in the block or blocks.

Any messages that are to be sent are sent under control of code executing in the machine sending the message. Thus, modules described herein can cause messages to be sent under program control and without human intervention in response to events and other triggers, automatically.

As noted above, the interface and all modules, software and code discussed herein can be constructed through program code that executes on a processor of a machine, e.g., as software in order to provide the functionality described herein.

It should be understood that the flow diagrams are for illustration and that an implementation of the present invention need not follow a linear flow path but instead could be event-driven. The flow diagrams, therefore, are simply an expedient for describing functional blocks in the operation of a particular embodiment of the invention and not as limiting the invention to the particular flow being illustrated.

As will be apparent to one skilled in the art, various modifications can be made within the scope of the foregoing description. Such modifications being within the ability of one skilled in the art form a part of the present invention and are embraced by the recitations in the claims set forth below and equivalents thereof.

I claim:

1. A computer-implemented system for managing user-selected web content, comprising:
a database connected to receive and store any user-selected web content in accordance with an organizational framework;
a client computer having a processor executing code so as to configure the client to provide a user-interface component through which a user selects web content and associates the user-selected web content with the framework;
a server computer connectable to the client and having a second processor executing a plurality of code modules that configure the server, including:
a communications module in communication with the user-interface component of the client to receive said content from any of a plurality of websites, store said content in the database, and push one or more alerts to the client;
a parser module operative to transform at least a portion of said content into a normalized text;
an extractor module operative to receive the normalized text and extract a set of terms;
an inference engine operative to compare at least the set of terms to an offer database using a criterion; and
an alert processor responsive to the comparison to construct said one or more alerts and serve said alerts via the communications module to the user-interface component of the client.

2. The computer-implemented system of claim 1, wherein the inference engine is further operative to derive one or more terms from the set of terms and to further compare said one or more derived terms to the offer database and wherein the alert processor constructs said one or more alerts in response to the comparison and the further comparison.

3. The computer-implemented system of claim 2, wherein the alert processor is further operative to determine a priority among said one or more alerts when there is more than one alert.

4. The computer-implemented system of claim 1, wherein the inference engine is continuously operative to compare at least the set of terms to an offer database using the criterion, and wherein the alert processor constructs said one or more alerts in response to the continuous comparison.

5. The computer-implemented system of claim 1, wherein the user-interface component of the client computer further comprises code responsive to any alert pushed by the server to provide an alert to the user of an arrival of any alert.

6. The computer-implemented system of claim 4, wherein each alert within the user-interface concerns an offer to book a hotel room or a flight, and wherein user-interface component of the client computer further comprises code responsive to user-selection of any alert to initiate a booking process at a website and external to the user-interface.

7. The computer-implemented system of claim 1, wherein the offer database is populated with offers from third-parties.

8. The computer-implemented system of claim 1, wherein the database includes a first table for storing said content and wherein the table stores said content in further association with a folder name input through the user interface and communicated to the server.

9. The computer-implemented system of claim 1, wherein the communications module is further operative to serve said content to the client on request.

10. A computer-implemented system for managing user-selected web content received from a client computer over a network, comprising:
a database connected to receive and store any user-selected web content in accordance with an organizational framework associated with the client;
a server computer connectable to the client and having a processor executing a plurality of code modules that configure the server, including:
a communications module in communication with the client to receive said content together with a location within the framework, store said content in the database using the location, and push one or more alerts to the client;
a parser module operative to transform at least a portion of said content associated with the location into a normalized text;
an extractor module operative to receive the normalized text and extract a set of terms;
an inference engine operative to compare at least the set of terms to an offer database using a criterion; and
an alert processor responsive to the comparison to construct said one or more alerts and serve said alerts via the communications module to the client.

11. The computer-implemented system of claim 10, wherein the inference engine is further operative to derive one or more terms from the set of terms and to further compare said one or more derived terms to the offer database and wherein the alert processor constructs said one or more alerts in response to the comparison and the further comparison.

12. The computer-implemented system of claim 11, wherein the alert processor is further operative to determine a priority among said one or more alerts when there is more than one alert.

13. The computer-implemented system of claim 10, wherein the inference engine is continuously operative to compare at least the set of terms to an offer database using the criterion, and wherein the alert processor constructs said one or more alerts in response to the continuous comparison.

14. The computer-implemented system of claim 10, wherein the offer database is populated with offers from third-parties.

15. The computer-implemented system of claim 10, wherein the database includes a first table for storing said content and wherein the table stores said content in further association with a folder name input through the user interface and communicated to the server.

16. The computer-implemented system of claim 10, wherein the communications module is further operative to serve said content to the client on request.
